(19) United States
(12) Patent Application Publication
(10) Pub. No.: US 2023/0419446 A1
(43) Pub. Date: Dec. 28, 2023

(54) METHOD FOR DIGITAL IMAGE PROCESSING

(71) Applicant: K|LENS GMBH, Saarbrücken (DE)

(72) Inventors: Klaus ILLGNER, Starnberg (DE); Samim Zahoor TARAY, München (DE); Sunil Prasad JAISWAL, Saarbrücken (DE)

(21) Appl. No.: 18/036,807

(22) PCT Filed: Nov. 16, 2021
(86) PCT No.: PCT/EP2021/081900

§ 371 Date: May 12, 2023

(30) Foreign Application Priority Data
Nov. 16, 2020 (DE) 10 2020 130 245.2
Nov. 16, 2020 (LU) LU102214

(51) Int. Cl. G06T 3/40; G06T 5/00

(52) U.S. Cl. CPC G06T 3/4046; G06T 5/002; G06T 2207/20084; G06T 2207/20081

(57) ABSTRACT

A method for digital image processing, including image processing of an original digital image for generating an image-processed digital image, reducing the resolution of the image-processed digital image for generating a starting digital image, wherein the original digital image and the starting digital image are used for forming a training data set for a machine learning system for increasing the resolution of digital images, in particular a neural network learning system. Furthermore, a method for digital image processing for generating digital images having an increased resolution from original digital images, a computer program product and to a device for carrying out the method.

### METHOD FOR DIGITAL IMAGE PROCESSING

The invention relates to a method for digital image processing for generating digital images which can be used for training a machine learning, in particular a neural network learning system.

Furthermore, the invention relates to a method for digital image processing for generating digital images having an increased resolution from original digital images.

Moreover, the invention relates to a computer program product and to a device being provided for carrying out the above-mentioned method.

In general, there is limitation of the image resolution of image capturing systems, because of various constraints on their technical components. Among others, the constraints are due to diffraction, i.e. the bending of light waves which occurs when light passes through a finite opening or aperture, and to practical technical limits of an optical lens of the image capturing system. For example, the optical lens can have aberrations, the sensor elements that record the intensity of light can only be packed up to a certain density and the process of recording invariably introduces noise in the measurement. Together, these constraints limit the resolution of the image capturing system which results in loss of fine details of objects in their recorded images.

Generating high resolution images from low resolution images is known from the state of the art. Most methods aim to simulate details and textures that fit with the input low image and produce a realistic looking higher resolution image to achieve this goal. Most such methods rely on a database consisting of paired low resolution and high resolution images. Scientific publications discussing this topic are “Example-based super-resolution”, William T Freeman, Thouis R Jones, and Egon C Pasztor, IEEE Computer Graphics, and “Super-resolution through neighbor embedding”, applications 22.2 (2002), pp. 56-65, and Hong Chang, Dit-Yan Yeung, and Yimin Xiong, Proceedings of the 2004 IEEE Computer Society Conference on Computer Vision and Pattern Recognition, 2004. CVPR 2004. Vol. 1. IEEE. 2004.

Even if there has been made some progress in improving the quality of resolution increase of computer-generated digital images, it remains a problem to increase the resolution of digital images that have been captured with real image capturing systems showing the constraints mentioned above, as the resulting digital images often do not appear natural.

It is an object of the invention to find a way to improve the quality of resolution increased images.

The method for digital image processing according to the present invention comprises providing an original digital image, image processing of the original digital image for generating an image-processed digital image, reducing the resolution of the image-processed digital image for generating a starting digital image, wherein the original digital image and the starting digital image are used for forming a training data set for a machine learning system for increasing the resolution of digital images, in particular a neural network learning system.

The method step of image processing is used for simulating the above-mentioned constraints of image capturing systems. Preferably, the image processing comprises altering the original digital image. After image processing, the resolution of the resulting digital image is reduced for forming the training data set comprising the original digital image and the starting image.

Expediently, the machine learning system uses artificial intelligence routines, in particular provided for increasing the resolution of digital images. Preferably, it is a deep learning system such as a convolutional neural network system. Convolutional neural network systems are known to be applied for visual image analysis. They typically are used in image and video recognition, image classification, and medical image analysis, among others. Furthermore, the machine learning system can be a deep neural network system, a deep belief network system or a recurrent neural network system.

Expediently, the machine learning system is suitably initialized or pre-trained for altering digital images, in particular for increasing the resolution of digital images. Preferably, suitable artificial intelligence initializing or training routines are used for initializing or pre-training the machine learning system. An example is the Residual in Residual Dense Network (RRDBNet) proposed in Xintao Wang, Ke Yu, Shixiang Wu, Jinjin Gu, Yihao Liu, Chao Dong, Yu Qiao, and Chen Change Loy. “ESRGAN: Enhanced Super-Resolution Generative Adversarial Networks”. In: European Conference on Computer Vision. Springer. 2018, pp. 63-79. However, other suitable networks could also be used.

The mentioned image processing expediently comprises altering the original digital image. In a preferred embodiment of the invention, the image processing and/or altering comprises denoising and/or blurring. Alternatively or additionally, the image processing may comprise altering of intensity, brightness and/or coloring of at least parts of the digital image, altering positions of at least individual pixels, altering intensities of the representation of at least individual ones of the pixels, vignetting or de-vignetting, and/or digital image filtering, e.g. for altering color, brightness and/or coloring.

Optionally, the method comprises an initial image processing step comprising an initial blurring of the original image with a 3×3, a 5×5, a 7×7 and/or a 9×9 gaussian blur kernel and/or a wavelet filter kernel and/or another blur filter kernel. Additionally or alternatively, the initial image processing step may comprise an initial resolution reduction. The initial image processing step preferably is carried out, if the original image is captured with an optical image capturing device.

Expediently, the blurring corresponds and/or is identical to a blurring of a real optical device and/or is derived from the blurring of a real optical, wherein the blurring of the real optical device preferably is measured. It is carried out to simulate the blurring which typically occurs when light passes through a real optical imaging system, e.g. an optical lens. Preferably, for carrying out the blurring, a blur kernel or/and a point spread function of the real optical device and/or representing the blurring of the real optical device is/are used. It has been found that using the blurring of a real optical device results in generation of starting images that are particularly well suited for training of machine learning systems. Such blurring of the real optical device preferably is measured using an optical measuring device.

In a further embodiment of the invention, the method is multiply performed using different original digital images for generating a larger quantity of digital images for training purposes.

Additionally, or in another embodiment of the invention, the method is multiply performed by using different image processing for generating a larger quantity of digital images for training purposes.

Advantageously, by using different original digital images and/or by using different image processing, it is possible to generate a multitude of trial images or pairs of trial and original images, respectively.

In a further embodiment of the invention, the method is multiply performed using different blurring, in particular blur kernels or/and a point spread functions, corresponding to different real optical devices and/or corresponding to different Gaussian filters, in particular 9×9, 7×7 and/or 5×5, Gaussian filters. Expediently, a data base comprising different data sets for blurring image processing is provided and, preferably randomly, distinct data sets are used for blurring. Expediently, the data set comprises different blur kernels and/or the point spread functions, in particular the blur kernels and/or the point spread functions mentioned above. In a particularly preferred embodiment of the invention, the different blurrings comprised in the data sets correspond to different real optical devices, preferably to optical devices customary in the market.

Expediently, for generating additional starting digital images usable for training, the image-processed, in particular the altered, digital image is flipped, preferably in different directions, e.g. horizontally and/or vertically.

In a particularly preferred embodiment of the invention, the real optical device is a plenoptical imaging system, in particular a kaleidoscope, preferably generating simultaneously multiple images of an object to be captured. Preferably, each of the multiple images is captured from different vantage points. Expediently, the blurring is carried out separately on each of the generated images using blur kernels and/or point spread functions. Preferably, for each of the generated images, different blur kernels and/or point spread functions are used.

In the preferred embodiment of the invention, the plenoptical imaging system, in particular for a camera, has a plurality of imaging means which are arranged in succession in the direction of an optical axis and comprise a first imaging means for generating a real intermediate image of an object in an intermediate image plane, a second imaging means for generating at least one virtual mirror image of the real intermediate image, which is arranged in the intermediate image plane offset from the real intermediate image, and a third imaging means for jointly imaging the real intermediate image and the virtual mirror image as a real image on an image receiving surface to be arranged at an axial distance from the intermediate image plane.

The kaleidoscope preferably is comprised of at least one pair of flat mirror surfaces, the mirror surfaces facing and spaced apart from each other. At least a part, preferably all, of the light paths pass through the space between the mirror surfaces. Preferably, the mirror surfaces are arranged parallel to each other. The kaleidoscope may have two or more pairs of mirrors. The pairs of mirrors can form a tube which is polygonal in cross-section, preferably rectangular. Alternatively, the kaleidoscope could be formed by a cylindrical glass rod with a polygonal cross-section, which has side surfaces and mirrored front surfaces for the entry and exit of light rays. The cross section of the glass rod is preferably in the shape of an isosceles triangle, a rectangle, especially a square, a regular pentagon, hexagon, heptagon or octagon.

Expediently, the imaging system comprises the image-receiving surface and means for processing a real image taken by means of the image-receiving surface. Preferably, the image-receiving surface has at least one image-receiving sensor or is formed by at least one image-receiving sensor. In the preferred embodiment of the invention, the image-receiving surface is formed by a single image-receiving sensor. The image-receiving sensor is preferably a CCD sensor or a CMOS sensor.

In a preferred embodiment of the invention, the blurring (B) or the blurrings (B, B1, B2, . . . , Bn), in particular the strength or the type of the blurring, differ in the image plane representing the image.

the blurring (B) or the blurrings (B, B1, B2, . . . , Bn) may not be identical in at least one direction of the image plane representing the image.

In a further embodiment of the invention, the blur kernels and/or point spread functions simulate the blurring being caused by the plenoptical imaging system, in particular the kaleidoscope, for each of the multiple images, in particular the real intermediate image and the at least one virtual mirror image, wherein the blur kernels and/or point spread functions for each of the multiple images can differ from each other. Expediently, the blur kernels and/or point spread functions may vary in at least one direction of the image plane representing the image, preferably within each of the multiple images. Preferably, the blurring being caused by the plenoptical imaging system is measured using an optical measuring device and the blur kernels and/or point spread functions are determined based on the measuring results.

In a further embodiment of the invention, the multiple images, in particular the real intermediate image and the at least one virtual mirror image, are processed separately. Expediently, the multiple images are separated from each other and processed independently according to a method according to the invention. Preferably, a separate machine learning system is trained for each of the multiple images, in particular for the real intermediate image and each of the virtual mirror images.

In a further embodiment of the invention, for generating the starting digital image, a reduction of the resolution of the image processed digital image is carried out after the blurring. Preferably, the resolution is reduced such that the resulting resolution corresponds to the resolution of an image whose resolution is to be increased by the process. Expediently, the method is multiply performed reducing the resolution in different degrees for generating different starting digital images. The different starting digital images can be used for the training of the machine learning system.

In a further embodiment of the invention, the image data format, in particular of the original digital image and/or any of the generated digital images, particularly the starting digital image, is changed, preferably in an image data format being provided for comprising non-processed or minimally processed data from an image sensor, preferably in a RAW image format. Expediently, the image data format is changed from the image data format of the original digital image which preferably is using an RGB color space, in particular sRGB. The image data format, from which image data format is changed may be TIFF, JPEG, GIF, BMP, PNG or the like. Preferably, the image data format is changed after blurring and/or after reduction of the resolution.

The change in the mentioned image data format is provided for being able to simulate especially accurate the process typically happening when a digital image is captured and processed in the digital image device, e.g. in the plenoptical imaging system mentioned above, in the image-receiving sensor and/or in the above-mentioned data processing device.

Typically, the RAW sensor image is transformed by the camera image signal processor (ISP) using several steps to arrive at a display ready sRGB image. For example, the RAW sensor image is gamma corrected and demosaiced. Demosaicing converts the single channel RAW data into three channel RGB data. The demosaicing step makes the noise spatially and chromatically correlated. Other processing steps like tone mapping, white balancing, color correction and/or compression may optionally be also applied to finally arrive at the display ready sRGB image. The net effect of all these steps is that the noise distribution present in the RAW images is heavily transformed during image processing.

In a further embodiment of the invention, the image processing comprises injection of noise. This injection of noise preferably simulates noise injection which typically occurs during electronic processing of the digital images in the course of their capture or/and their further processing.

In an embodiment of the invention, the noise source for modelling the noise to be injected to the raw images is modelled such that the noise process for each pixel is statistically independent of the noise process of neighboured pixels, in particular directly neighboured pixels. Alternatively, the noise source could be modelled such that the noise process for each pixel is statistically dependent of neighboured pixels, in particular directly neighboured pixels.

Preferably, noise according to a Poisson-Gaussian noise model is injected. Alternatively or additionally, noise injection according to a noise function measured for a specific image data processing device, e.g. of a photo and/or video camera body, photomultiplier cameras, spectral and/or multispectral camera and/or fluorescent camera, can be injected. Preferably, the noise injections being caused by image data processing device are measured using a noise measuring device and the noise functions are created based on the measuring results.

The noise which typically degrades an image and which is to be simulated originates and is transformed at the various stages of processing that are performed to arrive at the usually desired image. The process of recording an image of a scene starts at the photosites of a sensor which measure scene irradiance. The photosites are arranged in a two dimensional grid that constitutes the whole sensor. Each photosite counts the number of photons incident on it. Photon counting is a classical Poisson process and the uncertainty of the process gives rise to photon noise in the images. Therefore, the number of photons counted by each photosite can, be modelled as a Poisson distribution. The probability mass function of the Poisson distribution preferably is given by

$$P ( x = N ) = \frac{{λ}^{N} {e}^{- λ}}{N !} \qquad ( function 1 )$$

where N is the count of photons at the photosite and A is a parameter of the distribution that gives the expectation of the distribution. It is equal to the actual number of photons incident on the photosite and therefore is proportional to the scene irradiance. The amount of photon noise is given by the variance of the Poisson distribution. Poisson distributions have the property that their variance is equal to their expectation. Therefore, the amount of photon noise is also proportional to the scene irradiance. Photon noise constitutes the signal dependent part of noise in real world images. In modern digital camera sensors which are predominantly manufactured using the CMOS fabrication process, photon noise is the performance limiting noise component. The photon noise component preferably is modelled using a heteroskedastic Gaussian as follows:

N˜ [symbol] (λ,λ) (function 2)

The photon counts are stored as charge at each photosite which accumulates during the time period for which the sensor is exposed. Eventually, charge is converted into voltage, it is amplified, read out of the sensor, digitized and/or stored on the camera storage. The data at this point constitutes a RAW sensor image. The processes associated with amplification, reading and digitizing also introduce noise in the data. Together, this noise is usually termed read noise.

Expediently, it is assumed that read noise is signal independent and thus can be modelled as a zero mean Gaussian distribution. Preferably, a Poisson-Gaussian model for noise in the formation of RAW images is used given by

r=x+n (function 3)

where r is the noisy RAW image, x is a clean image and n is additive noise. Preferably, the noise n in the used model is assumed to follow a heteroskedastic Gaussian distribution i.e.

n˜ [symbol] (0,σ²(r)) (function 4)

The variance of noise σ2(r) preferably depends on the irradiance of the scene. It is given by)

σ²(r)=ar+b (function 5)

where a and b are the parameters that determine the strength of the signal-dependent photon noise and signal-independent read noise respectively. Expediently, the values of a and b depend on factors like the quantum efficiency of the sensor which determines how efficiently the sensor converts incident photons into charge, analog gain which is used to amplify the voltages and is determined by the ISO setting on the camera, the pedestal or the base charge that is always present in the sensor etc. In a preferred embodiment of the invention, a Poisson-Gaussian model for noise in the formation of RAW images according to Foi et al. in Alessandro Foi, Mejdi Trimeche, Vladimir Katkovnik, and Karen Egiazarian. “Practical Poissonian-Gaussian noise modeling and fitting for single-image raw-data”. In: IEEE Transactions on Image Processing 17.10 (2008), pp. 1737-1754 is used.

Preferably, for better simulating processes occurring during typical image data processing the change of the data format in an image data format being provided for comprising non-processed or minimally processed data is carried out before the injection of noise.

In a further embodiment of the invention, preferably after the injection of noise, the image data format is changed from the image data format being provided for comprising non-processed or minimally processed data from an image sensor, preferably from the RAW image format. Expediently, the image data format is changed to the image data format of the original digital image which preferably is using an RGB color space, in particular sRGB. In a particularly preferred embodiment of the invention, the resulting digital image is used as the mentioned starting digital image. If applying the processing to frames of a video signal, the preferred images data format is YCbCr.

The training data set preferably is provided for being used for training the machine learning system for increasing the resolution of digital images, in particular the neural network learning system.

In a preferred embodiment of the invention, the resolution of the starting image is increased using the, preferably pre-trained, machine learning system for generating a trial image. In the course of the training of the machine learning system, the trial image is compared with the original image and the machine learning system is trained using artificial intelligence training routines.

The machine learning system preferably is trained by processing the digital images forming probability-weighted associations, which are stored within the data structure of the system. The training preferably is conducted by determining the difference between the generated trial digital image and the original digital image. This difference corresponds to an error. The system adjusts its weighted associations according to a learning rule and using this error value. Successive adjustments will cause the neural network to produce output which is increasingly similar to the original digital image.

Expediently, machine learning system is optimized by minimizing the [symbol] ₁ loss between the output of the machine learning system and original digital image. The loss [symbol] ₁ can be written as:

[symbol]

₁=Eₓ_{ᵢ}∥G(xᵢ)−y∥₁

where G(xi) is the output of the machine learning system and y is the original image. The network parameters are updated by first taking the gradient of the loss with respect to the parameters and then stochatic gradient descent with Adam optimization is applied. The machine learning system preferably pre-trained with RRDBNet network (as mentioned above) with 23 RRDBs (Residual in Residual Dense Blocks). The network can be implemented in a program library suitable for machine learning such as the program library PyTorch. Preferably, a suitable optimizer, e.g. an ADAM optimizer (adaptive moment estimation), is used.

In a particularly preferred embodiment of the invention, conducting the training results in a machine-learning model.

Using the training method and/or the machine-learning model enables provision of an enhanced computer program or machine learning system for increasing the resolution of digital images.

The method according to the invention improves the results of training of a machine learning system in increasing the resolution of images captured with real optical image capturing devices starting from synthetically generated digital images or/and from digital images captured with an optical image capturing device.

Preferably, the method is used for processing single images, e.g. photographed or/and computer generated images, and/or image sequences, e.g. filmed, in particular by video recording, or/and computer generated.

In a further embodiment of the invention, the resolution of a digital image generated with an optical device is increased using the machine learning system having been trained carrying out any of the methods steps mentioned above.

In a further embodiment of the invention, the computer program product mentioned above comprises instructions which, when the program is executed by a computer, cause the computer to carry out steps of the methods mentioned above.

Furthermore, the invention relates to a computer program product for increasing digital image resolution comprising instructions which, when the program is executed by a computer, cause the computer to increase the resolution of a digital image using a machine learning system having been trained carrying out any of the methods steps mentioned above. The computer program product for increasing digital image resolution product trained for the real optical device, in particular the plenoptical device, preferably trained for a specific optical device, may be made available together with the mentioned real optical device. For example, it may be available as a file on a data storage medium comprising the trained machine learning system which may be physically connected to the optical device or as a signal sequence representing the data set which can be accessed via a computer network, e.g. the Internet. It would be conceivable to attach a link on the optical device, e.g. on the housing of the lens, to a file stored in the computer network, in particular the Internet.

Furthermore, the invention relates to a data carrier signal transmitting the computer program product.

In a further embodiment of the invention, the invention relates to a device for digital image processing, comprising means for carrying out the method outlined above. Expediently, the device for processing the digital image is constituted by a data processing device, in particular a computer, provided in particular for processing data read from the image capture sensor. In an embodiment of the invention, the data processing device is arranged in a housing of a camera which preferably forms part of the imaging system or is arranged for use with the imaging system.

The invention is explained in more detail below using exemplary embodiments and the accompanying drawings which relate to the exemplary embodiments and wherein:

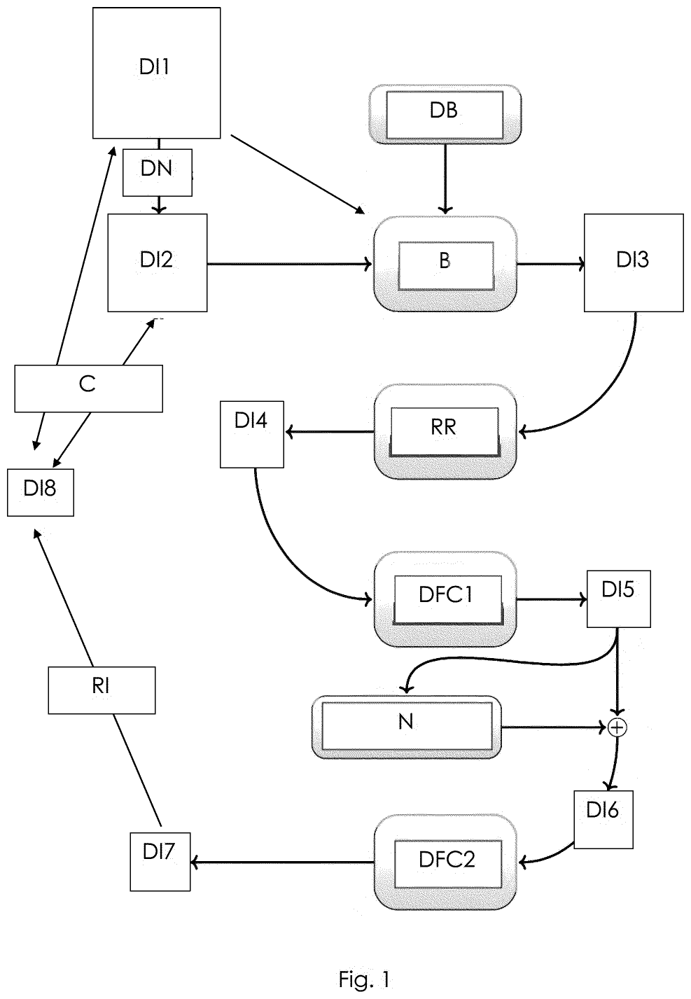

FIG. 1 schematically shows a method according to the invention,

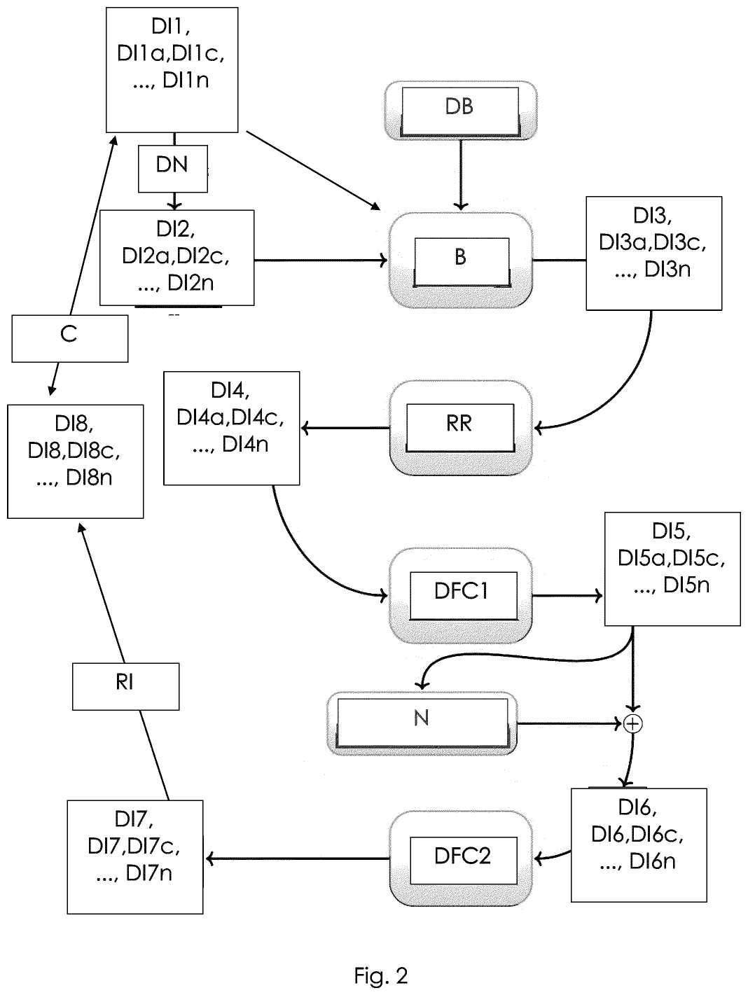

FIG. 2 schematically shows a method according to the invention,

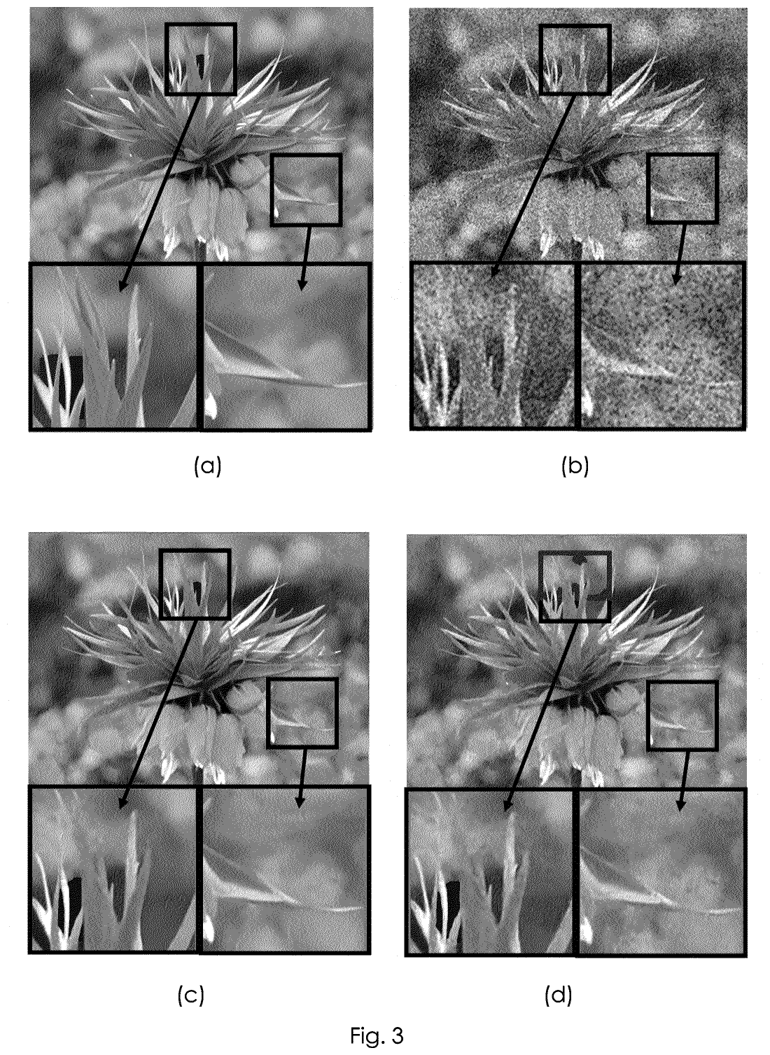

FIG. 3 shows different digital images used carrying out a method according to the invention,

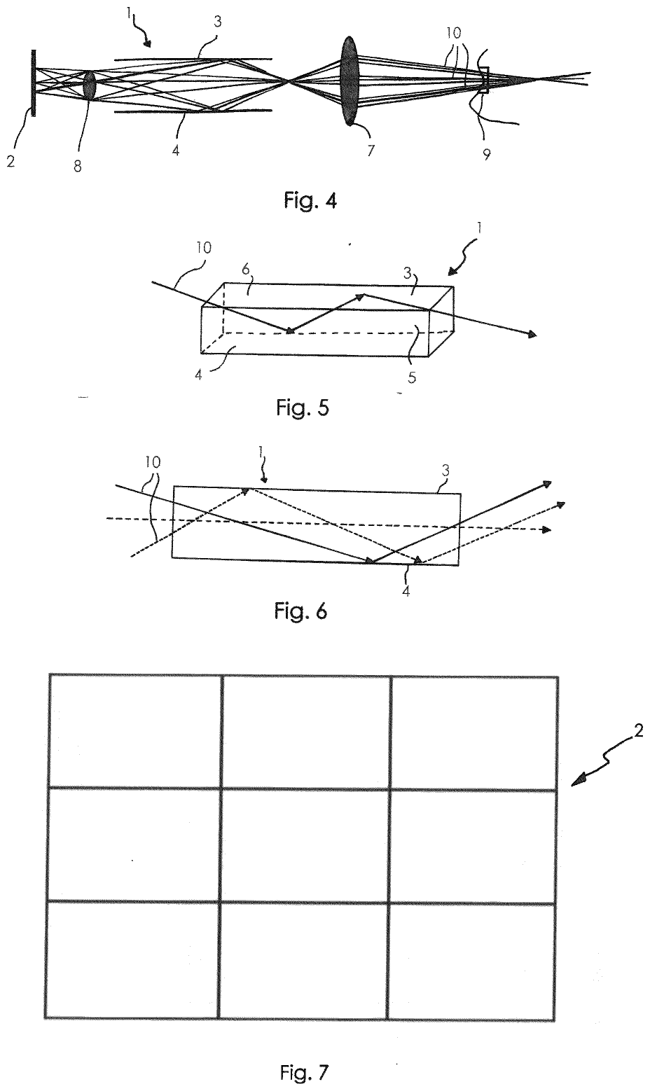

FIG. 4 schematically illustrates details of a plenoptical imaging system,

FIG. 5 schematically illustrates further details of a plenoptical imaging system,

FIG. 6 schematically illustrates further details of a plenoptical imaging system,

FIG. 7 schematically illustrates detail of the method, and

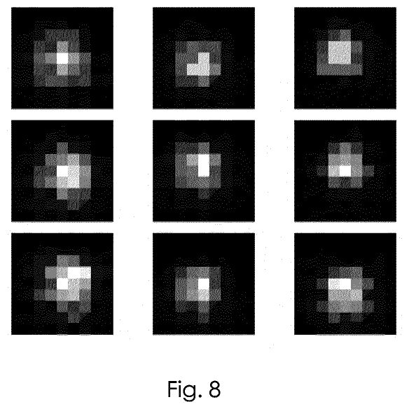

FIG. 8 illustrates point spread functions of a real optical device,

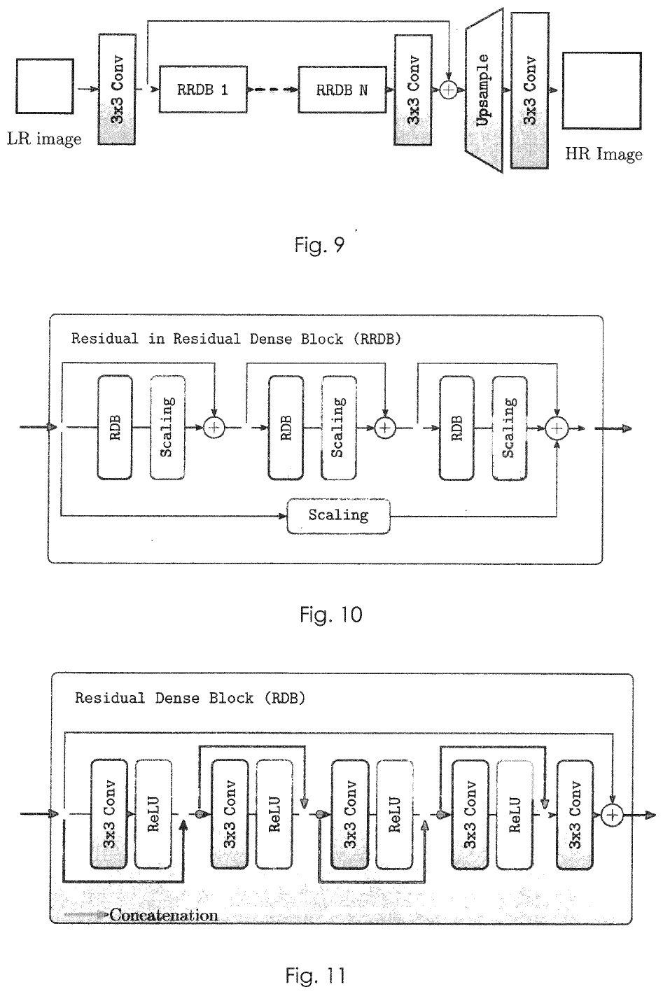

FIG. 9 schematically illustrates details of a machine learning system,

FIG. 10 schematically illustrates further details of a machine learning system according to FIG. 9,

FIG. 11 schematically illustrates further details of a machine learning system according to FIGS. 9 and 10,

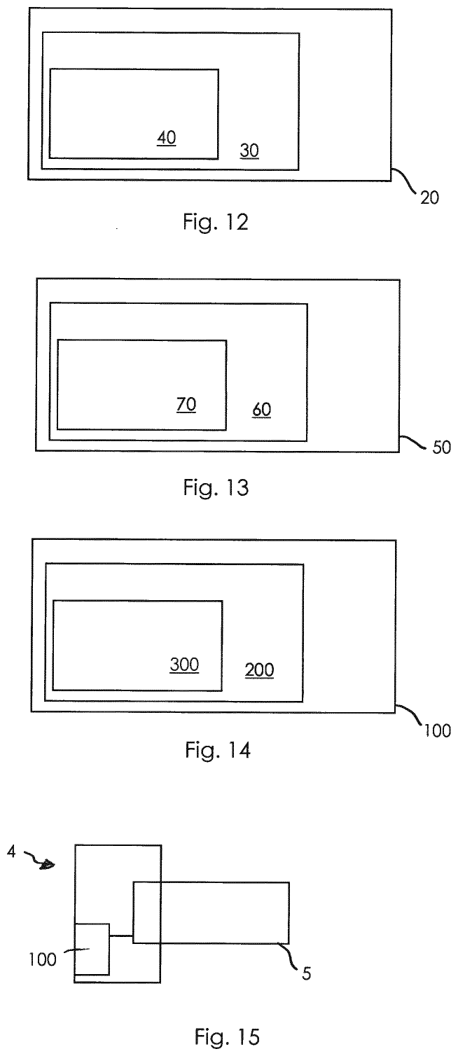

FIG. 12 schematically illustrates a device for digital image processing,

FIG. 13 schematically illustrates a further device for digital image processing, and

FIG. 14 schematically illustrates a camera system.

FIG. 1 illustrates schematically a method for digital image processing according to the invention.

An original digital image DI1 having an image data format using an RGB color space is stored in an image file, e.g. JPEG, GIF, PNG or TIFF.

In an optional process step DN, the original digital image DI1 is denoised, for example using a 3×3, 5×5, 7×7 and/or 9×9 gaussian blur kernel followed by an initial reduction of resolution. The process step DN results in a cleaned up original digital image DI2.

The original digital image DI1 or the cleaned up original image DI2 is blurred in process step B. Process step B is provided for simulating blurring that typically occurs in real optical imaging systems such as lenses. Process step B uses a blurring function stored as a data set in a data base DB. The data base DB contains different data sets of blurring functions corresponding to blurring occurring when a digital image is captured with different real optical devices and different Gaussian blur filters, in particular 9×9, 7×7 and/or 5×5 Gaussian filters. For carrying out the process step B, one of the data sets in the data base DB randomly is selected. A blurred digital image DI3 is generated.

In process step RR, a resolution of the blurred digital image DI3 is reduced for generating digital image DI4.

For generating a digital image that corresponds to a digital image captured with a real digital image capturing system, the data format of the digital image DI4 which typically is the same as of the original digital image DI1 (e.g. JPEG, GIF, PNG or TIFF) is changed in a RAW format in process step DFC1, preferably including the reduction of the color information into a mosaicked single band image.

The resulting digital image DI5 in RAW format is processed in noise injection step N, wherein noise is injected using a noise model according to the function DI3 mentioned above. A noise vector n(DI5) is generated by sampling from a heterokedostic Gaussian distribution, i.e.

n(rₛ)←N(0,σ²(rₛ))

where σ2(DI5) denotes the variance of the Gaussian distribution which is a function of the RAW digital image DI5 and is given by

σ2(DI5)=aDI5+b

In process step DFC2, the RAW file format of digital image DI6 generated in process step N is demosaiced and changed into a multi-colour band data format using, preferably as RGB or YCbCr color space. For example, such image can be stored in file formats like JPEG, GIF, PNG, TIFF or others. Preferably, the image is stored in the same image data format and the same file format as the original digital image DI1 or the cleaned up original digital image DI2.

The process step DFC2 generates a starting digital image DI7 being provided to be used for training a machine learning system which can be used for increasing the resolution of digital images.

For training purposes, the machine learning system increases the resolution of the starting digital image DI7 in process step RI. In the course of the training in step C, the generated trial digital image DI8 having the increased resolution is used with original digital image DI1 or cleaned up original digital image DI2, respectively.

The machine learning system is a deep learning system known from the state of the art such as a convolutional neural network system. An according machine learning system is described in the scientific publication of Xintao Wang, Ke Yu, Shixiang Wu, Jinjin Gu, Yihao Liu, Chao Dong, Yu Qiao, and Chen Change Loy. “ESRGAN: Enhanced Super-Resolution Generative Adversarial Networks”. In: European Conference on Computer Vision. Springer. 2018, pp. 63-79. The machine learning system is optimized by minimizing the [symbol] ₁loss between the output of the machine learning system and original digital image. The loss [symbol] ₁ can be written as:

[symbol]

₁=Eₓ_{ᵢ}∥G(xᵢ)−y∥₁

where G(xi) is the output of the machine learning system and y is the original image. The network parameters are updated by first taking the gradient of the loss with respect to the parameters and then stochatic gradient descent with an Adam optimization (adaptive moment estimation) is applied. The machine learning system preferably pre-trained with an RRDBNet network with 23 RRDBs (Residual in Residual Dense Blocks). The network can be implemented in a program library suitable for machine learning such as the program library PyTorch. The Adam optimizer is built with β1=0.86 and β2=0.97 and an initial learning rate of 3×10⁻⁴ for optimization. We set the batch size to 26 and train the network for 550 epochs. Training the network using a graphic card “Nvidia Quadro 6000 RTX” takes around 10 hours.

The machine learning system network design follows the established conventions. The first part of the network consists of an initial convolution layer to transform the image into the feature space. This is followed by several basic blocks where most of the computation takes place. The resulting features are upsampled using a convolution transpose layer. The upsampled features are compressed to 3 channels via the final convolution layer generating image having the high resolution. The architecture of the RRDBNet network is shown in FIG. 9. The network consists of an initial convolution layer followed by a series of Residual in Residual Dense blocks to extract features. Finally, the features are upsampled and compressed for generating the image having the increased resolution.

The basic block is the Residual in Residual Dense Block (RRDB). It is composed of three Residual Dense Blocks (RDB) with skip connections in between. The skip connections are achieved by adding the input feature maps to the output feature maps of each block and therefore having a path which skips the block as depicted in FIG. 10. Skip connections ensure that a block has to learn only the residual mapping from the input and thus enable training of deep networks with several convolution layers. Scaling the values of the feature maps by a constant between 0 and 1 before applying skip connection to the input of the block stabilizes training because with a large number of layers and corresponding skip connection, the values in the feature map can become very large.

The Residual Dense Blocks (RDBs) which make up the basic block of the network are composed of 4 convolution layers each followed by a ReLU(x) non-linearity given by

$$R e L U ( x ) = \{ \begin{matrix}x & if x > 0 , \\ 0 & otherwise\end{matrix}$$

The output of each convolution layer is concatenated with the output of all previous layers within the block including the input which becomes the input to the next layer. This makes the layers in the block densely connected. The architecture of a single RDB is depicted in FIG. 11. The RDB consists of four convolution layers. Dense connections are achieved by concatenating outputs of all previous layers. A skip connection to the input of the block is applied. The concatenated outputs of all the convolution layers within the dense block are finally compressed using a final convolution layer. This is followed by a skip connection to the input of the block for residual learning.

Furthermore, the machine learning system could be a deep neural network system, a deep belief network system or a recurrent neural network system.

For increasing the quality of digital images or pairs of digital images for training purposes, the method or single steps of the method can multiply be carried out (see FIG. 2):
a) using different original digital images (DI1, DI1a, DI1b, . . . , DI1n),
b) in process step B using different blurrings for processing identical or different original digital images (DI1, DI1a, DI1b, . . . , DI1n or/and DI2, DI2a, DI2b, . . . , DI2n),
c) in process step RR using different degrees of resolution reduction for processing identically or differently blurred digital images (DI3, DI3a, DI3b, . . . , DI3n),
d) in process step N using different injections of noise for processing identical or different digital images (DI5, DI5a, DI5b, . . . , DI5n), and/or
e) in process step RI using different degrees of increase of identical or different digital starting images (DI7, DI7a, DI7b, . . . , DI7n) for generating trial images (DI8, DI8a, DI8b, . . . , DI8n).
f) in process step C using the different generated digital trial images (DI8, DI8a, DI8b, . . . , DI8n) in combination with the respective original digital images (DI1, DI1a, DI1b, . . . , DI1n) or/and with the respective cleaned up original image (DI2, DI2a, DI2b, . . . , DI2n), for training the machine learning system.

FIG. 3 shows different digital images. An original digital image DI1 shown in FIG. 3a has been captured using a camera of type “Sony Xperia Smartphone”.

Each group of images (a), (b), (c) and (d) shown in FIG. 3 comprises each on the lower side two enlarged sections of the respective digital image DI1,DI7,DI8a,DI8b shown on the upper side. The sections being enlarged are framed in the digital image on the upper side.

FIG. 3a shows an original digital image corresponding to original digital image DI1 of FIG. 1. The digital image shown in FIG. 3b shows a digital image corresponding to starting digital image DI7. The images in FIGS. 3c and 3d are different digital image DI8a and DI8b, respectively, whose resolution has been increased from the image of FIG. 3b using differently trained convolutional neural network systems. The image DI8a in FIG. 3c is generated with a convolutional neural network system having been trained for higher levels of noise and image DI8b in FIG. 3d is generated with a convolutional neural network system having been trained for lower levels of noise. The image in FIG. 3d less accurate and contains blotchy artifacts. Such artifacts are not present in FIG. 3d which suggest that they arise because convolutional neural network system having been trained for lower levels of noise is not trained for the level of noise present in the input image.

In a further example, the method according to the invention has been conducted using original digital images which have been captured using a plenoptical imaging system, in particular a plenoptical imaging system comprising a kaleidoscope, generating simultaneously multiple images of an object to be captured. Some details of the plenoptical imaging system are outlined above. Furthermore, FIG. 4 shows schematically how, in accordance with the invention, a plenoptical image capture is produced using a plenoptical imaging device 1 comprising a kaleidoscope which, in addition to an entrance lens 7 and an exit lens 8, has a mirror box comprising mirrors 3,4,5,6 which forms a kaleidoscope. The mirrors 3,4,5,6 are, as shown in FIGS. 5 and 6, arranged in a rectangular cross-section in the mirror box, with the mirror surfaces of the mirrors being arranged on the inside of the mirror box. Rays of light 10 emanating from an object area 9, which images an object, enter the entrance lens 7 and are directed through the entrance lens into the interior of a mirror box. Some of the light rays 10 pass through the mirror box to the exit lens 8 without striking any of the mirrors 3,4,5,6, while other light rays are reflected only once at one of the mirrors 3,4,5,6 before striking the exit lens 8. Other light rays, in turn, are reflected several times within the mirror box at mirrors 3,4,5,6, whereby reflection can occur both at opposite mirrors 3,4,5,6 and at mirrors 3,4,5,6 arranged adjacent to one another. The exit lens 8 is arranged in such a way that the light rays emerging from the mirror box are guided to your receiver surface 2, which is formed by a sensor, in particular a CCD or CMOS sensor.

The entrance lens 7, the mirrors 3,4,5,6, and the exit lens 8 are arranged in such a way that nine images of the object area are formed on the receiver surface 2, which are generated next to each other in a 3×3 grid such as shown in FIG. 7. The images are generated in such a way that they form the object area starting from the entrance lens 7 from nine different perspectives or, in other words, angles of view. Alternatively, the entrance lens 7, the mirrors 3,4,5,6 and the exit lens 8 could be arranged in such a way that N×N images of the object area are formed on the receptor surface and generated next to each other in an N×N grid, where N represents an odd number. In addition to the above-mentioned raster, 25 images of the object area in a 5×5 raster or 49 images in a 7×7 raster can be considered. It goes without saying that in order to increase the number of viewing angles that can be achieved, larger numbers of illustrations and corresponding raster arrangements can also be provided.

In the present example, the plenoptical imaging device 1 comprises a plenoptical imaging device comprising a kaleidoscope of the applicant K Lens GmbH. The plenoptical imaging device 1 is arranged in a lens body comprising the components outlined above. It comprises a mounting mechanism (“lens mount”) for mounting the lens body on an actual camera body, e.g. the above mentioned “Nikon D810” or the like. It allows imaging of 9 different perspectives of a scene using a single shot on a single camera sensor. The different perspectives can be used for a host of post-processing tasks and applications like depth estimation, post capture focus etc. Since the sensor now captures 9 different perspectives, the number of pixels for each perspective is about 1/9 of the number of pixels of the full sensor. The goal is to find a way to enhance the resolution of each view.

For blurring the original digital images in step B, blurring functions are used which correspond to blurring occurring when a digital image is captured with the plenoptical imaging system.

Such blurring has been measured for the plenoptical imaging device as follows. A point source of light (white LED light around a covering with a single 30 μm hole) has been imaged in a dark room using the plenoptical imaging device comprising of K Lens GmbH with Nikon D810 camera. To obtain estimates at different spatial positions, we image the point source on a regular 3×3 grid. The exposure time has been set to ⅙ seconds and ISO to 100. To extract the PSF, we crop a window of 9×9 pixels around the brightest point in each image. This window becomes the PSF at that position and the measured PSFs from our experiment are shown in FIG. 8. FIG. 8 illustrates that the point spread functions differ for each of the 9 sections of the 3×3 grid.

Based on these measuring results, at least one blurring function, preferably various blurring functions, varying in the image plane representing the image correspondingly are generated and provided in the database DB. Accordingly, at least blurring function adapted to the present plenoptical imaging device can be provided. As the described type of plenoptical device has a relatively complex mechanical structure and for that reason each plenoptical device of that type has slightly different optical characteristics, in particular its own specific point spread function, it is possible to train a machine learning system specifically for each plenoptical device. This makes it possible to reach particularly good results in increasing the resolution of the captured digital images.

In a further example, the section of the digital images captured with the plenoptical imaging device mentioned above are separated from each other. The separated image sections are used for training different machine learning systems. Different trainings are carried out for each of the 9 sections of the 3×3 grid so that different trained machine learning systems, in particular different trained neural networks, are provided for each of the sections.

FIG. 12 schematically illustrates a computer device 20 for processing digital images. The device 20 comprises means, in particular suitable computer hardware 2 and software 40 for carrying out at least one of the methods or/and method steps for generating digital images being suitable for training a machine learning system as mentioned above. The software 40 comprises instructions which, when the program is executed by the computer device, cause the computer device 20 to carry out the steps of the method and/or the method steps.

FIG. 13 schematically illustrates a computer device 50 for processing digital images. The device 50 comprises computer hardware 60 and provided thereon a deep learning system 70, e.g. a convolutional neural network system as mentioned above. The deep learning system 70 is trained as outlined above and using the digital images generated as mentioned above.

FIG. 14 schematically illustrates a computer device 100 for processing digital images. The device 100 comprises means, in particular suitable computer hardware 200 and software 300, for carrying out at least one of the methods or/and method steps for processing digital images using a trained machine-learning model which is trained in accordance with the methods mentioned above.

The software 300 comprises instructions which, when the program is executed by the computer device, cause the computer device 20 to carry out the steps for processing digital images using the trained machine-learning model.

FIG. 15 schematically shows a camera system 4 comprising an image capturing system 5 comprising an optical lens and means for image capturing as well as a computer device 100 according to FIG. 13. The camera system 4 is provided such that the computer device 100 can increase the resolution of digital images captured with the image capturing system 5 using the trained machine-learning model.

1-23. (canceled)

24. A digital image processing method, comprising the steps of:
image-processing an original digital image for generating an image-processed digital image;
reducing the resolution of the image-processed digital image for generating a starting digital image;
using the original digital image and the starting digital image for forming a training data set for a machine learning system for increasing the resolution of digital images.

25. The method according to claim 24, wherein the machine learning system is a neural network learning system.

26. The method according to claim 24, wherein the image processing includes altering the original digital image.

27. The method according to claim 26, wherein the altering of the original digital image includes denoising and/or blurring.

28. The method according to claim 27, wherein the blurring corresponds to a blurring of a real optical device.

29. The method according to claim 28, wherein the blurring is carried using a blurring kernel and/or a point spread function.

30. The method according to claim 24, including performing the method steps multiply using different original digital images and/or carrying out different image processings.

31. The method according to claim 30, wherein the method is multiply performed using different blurrings, each blurring corresponding to a different real optical device.

32. The method according to claim 30, wherein the method is multiply performed using different blurrings, each corresponding to different Gaussian filters.

33. The method according to claim 27, wherein the blurring or the blurrings differ in the image plane representing the image.

34. The method according to claim 33, wherein the blurring or the blurrings differ in strength or type of blurring.

35. The method according to claim 28, wherein the real optical device is a plenoptical imaging system.

36. The method according to claim 35, wherein the real optical device is a kaleidoscope.

37. The method according to claim 35, wherein the plenoptical imaging system generates multiple images of an object to be captured.

38. The method according to claim 24, wherein the image processing includes injecting noise.

39. The method according to claim 38, including injecting realistic noise according to a Poisson-Gaussian noise model.

40. The method according to claim 38, including changing an image data format.

41. The method according to claim 40, including providing for an image data format comprising non-processed or minimally processed data from an image sensor.

42. The method according to claim 41, wherein the image data format is a RAW image format.

43. The method according to claim 41, including carrying out the changing of the image data format before the injection of noise and after the injection of noise, changing the image data format in the image data format of the original digital image which is using an RGB color space, the resulting digital image forming the starting digital image for generating the trial digital image.

44. The method according to claim 24, including using the original digital image and the starting digital image for training the machine learning system.

45. The method according to claim 44, wherein the training includes increasing the resolution of the starting digital image for generating a trial digital image.

46. The method according to claim 45, wherein the training includes comparing the trial digital image with the original digital image.

47. The method according to claim 24, including increasing the resolution of a digital image generated with an optical device using the machine learning system having been trained using the training data set.

48. A method for digital image processing, wherein resolution of a digital image a digital image generated with an optical device, is increased using a machine learning system that is trained by carrying out the steps according to claim 24.

49. A computer program product, comprising instructions which, when the program is executed by a computer, cause the computer to carry out the steps of the method according to claim 24.

50. The computer program product according to claim 49, wherein the computer program product is a computer program stored on a data carrier, a device, a device with an embedded processor, a computer embedded in a device, a smartphone, a computer of a device for producing an image recording, or is a signal sequence representing data suitable for transmission via a computer network.

51. The computer program product according to claim 50, wherein the wherein the data carrier is a RAM, ROM or CD.

52. The computer program product according to claim 50, wherein the device is a personal computer.

53. The computer program product according to claim 50, wherein the device for producing an image recording is a photo and/or video camera.

54. A device for digital image processing, comprising means for carrying out the method according to claim 24.

55. A trained machine-learning model trained in accordance with the method according to claim 44.

56. A device for digital image processing, using the trained machine-learning model according to claim 55, for increasing resolution of a digital image.

57. The device for digital image processing according to claim 54, wherein the device is part of an image capturing system.

58. A data carrier signal that transmits the computer program product according to claim 49.
